(19) United States
(12) Patent Application Publication
(10) Pub. No.: US 2006/0202392 A1
(43) Pub. Date: Sep. 14, 2006

(54) Tunable mask apparatus and process

(75) Inventor: Yuebing Zheng, Singapore (SG)

Correspondence Address: DINSMORE & SHOHL LLP;One Dayton Centre, Suite 1300, One South Main Street, Dayton, OH, 45402-2023, US

(73) Assignee: Agency for Science, Technology and Research

(21) Appl. No.: 11/374,508

(22) Filed: Mar. 13, 2006

Related U.S. Application Data
(60) Provisional application No. 60/661,984, filed on Mar. 14, 2005.

(51) Int. Cl. B23K 26/36; B29C 35/08

(52) U.S. Cl. 264/400

(57) ABSTRACT

A process for re-shaping spheres in an exposed layer of spheres on a substrate having a substrate surface is disclosed. The process involves exposing the exposed layer of spheres to a low-angle ion beam, while maintaining the low-angle ion beam at a power level for a time sufficient to ablate the spheres in the exposed layer into respective spaced apart sphere segments which define a mask on the substrate surface. Two layers of spheres may be used, with only the outer, exposed layer being exposed to the low-angle ion beam, to cause the sphere segments of the exposed layer and spheres of the layer below to cooperate to define a mask having very small openings.

### CROSS-REFERENCES TO RELATED APPLICATIONS

This application claims the benefit of U.S. Provisional Application No. 60/661,984 filed Mar. 14, 2005, which is incorporated herein by reference.

### BACKGROUND OF THE INVENTION

1. Field of Invention

This invention relates to lithography and more particularly to small or nanosphere lithography and even more particularly to a tunable mask apparatus and method involving reshaping spheres on a substrate with minimal or no effect on the substrate.

2. Description of Related Art

Nanosphere lithography (NSL) is an inexpensive inherently parallel, high throughput and materials-general technique operable to be used to produce well ordered two-dimensional periodic arrays of nanoparticles.

Generally, NSL involves deposition of material onto a substrate and/or etching material from the substrate to form a desired pattern thereon. Deposition techniques may be used to form dots on a surface of the substrate, for example and etching techniques may be used to form holes in the surface of the substrate, for example.

One form of nanosphere lithography involves providing drops of mono-dispersed polystyrene sphere suspension over a silicon substrate to form a suspension-covered substrate and then submerging the suspension covered substrate in de-ionized (DI) water. A randomly arranged monolayer of polystyrene spheres is then arranged on an upper surface of the DI water. A small amount of SDS solution (CH₃(CH₂)₁₁OSONa) is then added to drive the randomly arranged spheres into a closely packed monolayer of spheres. The submerged substrate is then withdrawn from the DI water to transfer the closely packed mono layer of spheres onto the substrate. The substrate is then dried, leaving the spheres secured to the substrate.

The spheres may then be reshaped using any of various methods to leave units of polystyrene material on the surface of the substrate in a desired shape and pattern thereby forming a masked substrate. This masked substrate may then be used in subsequent processing steps involving etching and/or ablation or deposition for example, to form nano structures or nano openings in the substrate so that the substrate can be used in a desired application. For example, deposition techniques are described by U. C. Fischer, H. P. Zingsheim, J. Vac. Sci. Technol. 19, 881 (1981) and J. C. Hulteen, R. P. Van Duyne, J. Vac. Sci. Technol. A13, 1533 (1995) which disclose vertical deposition of metal and tilted angle deposition of metal respectively. Etching techniques are described by H. W. Deckman, J. H. Dunsmuir, Appl. Phys. Lett. 41, 377 (1982); and A. V. Whitney, B. D. Myers, R. P. Van Duyne, Nano Lett. 4, 1507 (2004) which disclose Vertical reactive ion etching (RIE), and tilted-angle RIE respectively.

Of course, the arrangement and shape of the nanostructures formed in or on the substrate depend upon the arrangement and shapes of the nanospheres. Some techniques may be used with the nanospheres in their primordial spherical form while other techniques involve re-shaping the nanospheres to form the desired shapes and arrangements of nanostructures in the substrate. An example of such re-shaping is described by C. Haginoya, M. Ishibashi, and K. Koike, Appl. Phys. Lett. 71, 2934 (1997) which discloses Vertical RIE of nanospheres with O₂.

Shaping of nanospheres prior to deposition or etching is desirable because it allows for more accurate control over the size, shape and arrangement of nanosphere structures. The use of Vertical RIE with O₂ described above is useful but has limitations in that it requires that the etching rate of the nanospheres be different from the etching rate of the substrate, which limits its use to applications involving materials that meet this criterion. Furthermore the use of vertical RIE with O₂ can be expensive and can have throughput limitations that make it undesirable for use in commercial nanostructure formation processes.

### SUMMARY OF THE INVENTION

The present invention provides a substrate-independent way of re-shaping spheres used in sphere lithography and more particularly nanosphere lithography.

In accordance with one aspect of the invention, there is provided a process for re-shaping spheres in an exposed layer of spheres on a substrate having a substrate surface. The process involves exposing the exposed layer of spheres to a low-angle ion beam, while maintaining the low-angle ion beam at a power level for a time sufficient to ablate the spheres in the exposed layer into respective spaced apart sphere segments.

Exposing may involve causing the low-angle ion beam to be directed at the spheres in the exposed layer in a direction nearly parallel to a tangent of the substrate surface and spaced apart from the substrate surface.

Maintaining the low-angle ion beam at a power level may involve maintaining the low-angle ion beam at a power level for a time sufficient to form generally planar surfaces in the spheres in the exposed layer, the generally planar surfaces being generally coplanar.

Maintaining the low-angle ion beam at a power level for a time sufficient to create generally planar surfaces may involve maintaining the low-angle ion beam at a power level for a time sufficient to create generally planar circular surfaces in the spheres in the exposed layer. The generally planar circular surfaces may have a final diameter less than an initial diameter of a respective sphere in which they are formed.

The process may further involve causing the substrate and ion beam to move relative to each other. Causing the substrate and ion beam to move relative to each other may involve maintaining the ion beam in a position while rotating the substrate. The substrate may be rotated in a plane nearly parallel to the direction of the low-angle ion beam.

The process may involve exposing the exposed layer of spheres to the low-angle ion beam. The ion beam may polish the exposed layer of spheres.

The exposed layer may be directly on the substrate surface.

The exposed layer may be on a substrate layer of spheres and the substrate layer of spheres may be directly on the substrate surface.

The spheres may have an initial diameter of between about 70 nm to about 5 μm.

The spheres may be nanospheres.

In accordance with another aspect of the invention, there is provided a process for forming a mask on a substrate surface. The process involves causing a plurality of spheres to arrange into at least one layer of spheres on the substrate surface including an exposed layer of spheres, each of the spheres having a first diameter. Then the process described above may be executed to re-shape the spheres in the exposed layer, using a low-angle ion beam.

Causing the plurality of spheres to arrange into the at least one layer of spheres may involve causing the plurality of spheres to arrange into a single layer of spheres on the substrate surface, the single layer of spheres being the exposed layer of spheres.

Causing the plurality of spheres to arrange into the at least one layer may involve causing the spheres to arrange into a substrate layer directly on the substrate surface and an exposed layer directly on the substrate layer.

In accordance with another aspect of the invention, there is provided a process for producing a nanostructure array. The process involves executing the process described above so that the sphere segments in the exposed layer cover respective areas of the substrate surface and interstices between respective sphere segments define uncovered areas of the substrate surface. The process may then further involve etching the uncovered areas of the substrate surface, ablating the uncovered areas of the substrate surface, and/or depositing material on the uncovered areas of the substrate surface.

Where the plurality of spheres are arranged into a substrate layer of spheres and an exposed layer of spheres, the substrate layer of spheres being on the substrate surface and the exposed layer of spheres being on the substrate layer of spheres, and the exposed layer of spheres is formed into sphere segments by a low-angle ion beam such that the sphere segments in the exposed layer and the spheres in the substrate layer define respective covered areas of the substrate surface and interstices between the sphere segments and interstices between spheres of the substrate layer define uncovered areas of the substrate surface, different processes for producing a nanostructure array may involve etching the uncovered areas of the substrate, ablating the uncovered areas of the substrate, or depositing material on the uncovered areas of the substrate.

A nanostructure array apparatus may be produced according to any of the processes described above.

In accordance with another aspect of the invention, there is provided a masked substrate apparatus for use in forming a nanostructure array. The apparatus includes a substrate having a substrate surface. The apparatus further includes a plurality of spheres in a substrate layer of spheres on the substrate surface. A first set of interstices is formed between adjacent spheres of the substrate layer. A plurality of sphere segments are in an exposed layer of sphere segments on the substrate layer of spheres. The sphere segments are arranged in spaced apart relation to form a second set of interstices between adjacent sphere segments. The interstices of the first set and the interstices of the second set have overlapping areas defining uncovered areas on the substrate surface. The spheres of the substrate layer and the sphere segments of the exposed layer cover areas of the substrate surface to define covered areas of the substrate surface.

Each of the sphere segments may have a curved surface and a generally planar surface, the planar surface having been formed by a low-angle ion beam. The sphere segments may be on the substrate layer of spheres on the substrate surface such that the curved surfaces of the sphere segments face generally toward the substrate layer of spheres and the generally planar surfaces of the sphere segments face away from the substrate layer of spheres.

The substrate surface may be generally planar. The generally planar surfaces of the sphere segments may generally lie in a common plane spaced apart from the substrate surface.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a pictorial view of a floating gate flash memory cell produced using processes and apparatuses according to various embodiments of the invention described herein;

FIG. 2 is a process flow diagram showing various stages of processing a substrate with a single layer of spheres to produce recesses or projections in a surface of the substrate;

FIG. 3 is a process flow diagram showing various stages of processing a substrate with two layers of spheres to produce recesses or projections in the surface of the substrate;

FIG. 4 is a detailed cross-sectional view of a section through a substrate having a substrate layer of spheres and an exposed layer of spheres where the exposed layer of spheres has been ablated by an ion beam;

FIG. 5 is a picture of a surface of a substrate having a single layer of spheres thereon;

FIG. 6 is a picture of the substrate of FIG. 5 after the spheres in the single layer have been ablated by the ion beam;

FIG. 7 is a picture of the substrate shown in FIG. 6 after etching using the sphere segments shown in FIG. 6 as a mask on the substrate surface;

FIG. 8 is a picture of the substrate surface with a substrate layer of spheres and an exposed layer of spheres on the substrate layer of spheres;

FIG. 9 is a picture of the substrate shown in FIG. 8 after the exposed layer of spheres has been exposed to an ion beam;

FIG. 10 is a picture of the substrate shown in FIG. 9 after etching using the substrate layer of spheres and the exposed layer of sphere segments shown in FIG. 9 as an etching mask.

### DETAILED DESCRIPTION

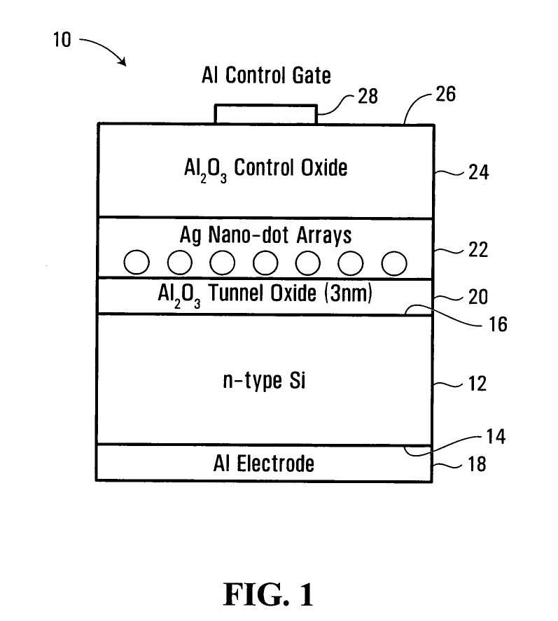

Described below is a floating gate flash memory cell produced using processes and apparatus produced by those processes according to various embodiments of the invention. Referring to FIG. 1, the floating gate flash memory cell is shown generally at 10 and includes an n-type silicon substrate 12 having first and second surfaces 14 and 16, respectively. On the first surface 14, an aluminum electrode 18 has been formed using a conventional process.

The second surface 16 has been treated with hydrofluoric acid and a thin film 20 of aluminum oxide (AL₂O₃) having a thickness of approximately 3 nanometers was deposited thereon. On the thin film 20, an ordered silver nano-dot array was fabricated using a method according to one embodiment of the invention. After the nano-dot array 22 was formed, a second thin film of aluminum oxide 24 having a thickness of approximately 10 nanometers was deposited on the silver nano-dot array 22. The second thin film 24 has an outer surface 26 on which was formed an aluminum control gate 28 in a conventional manner.

The process for forming the silver nano-dot array 22 is a special adaptation of a more general process according to a first embodiment of the invention, involving a process for forming a mask on a substrate surface and etching, ablating or depositing material using the mask to define areas of etching, ablation or deposition. Process steps for effecting etching, ablation or deposition are known in the prior art and may be achieved by any of a plurality of different methods. The process for forming the mask on the substrate surface however, is of more interest here and is described in greater detail below.

Process for Forming a Mask

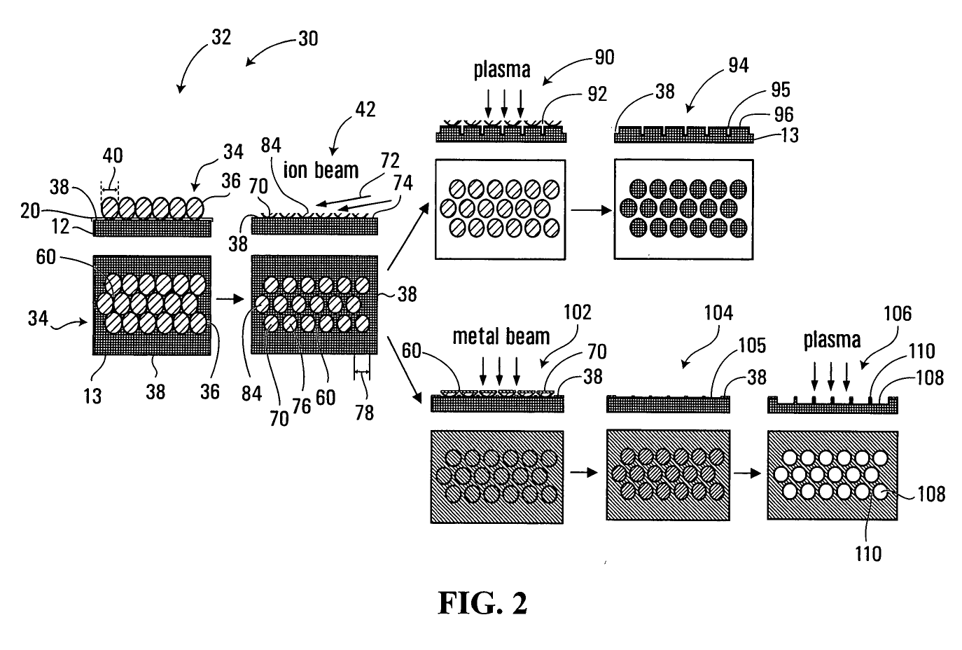

Referring to FIG. 2, the process for forming a mask on a substrate surface is shown generally at 30 and generally involves a process 32 for causing a plurality of spheres 36 to arrange into at least one layer 34 on the substrate surface 38. In this embodiment, the substrate surface is provided by the thin film 20 of aluminum oxide on the silicon substrate 12. For ease of description, the silicon substrate 12 with the thin film 20 of aluminum oxide thereon will be regarded as the “substrate” 13, and the surface of the thin film of aluminum oxide will be regarded as the substrate surface 38.

Each of the spheres 36 has a first diameter 40 and the at least one layer 34 in this embodiment acts as an exposed layer of spheres. An exposed layer of spheres is one which is uncovered by other layers of spheres or other materials.

After the spheres 36 have been arranged into at least one exposed layer 34, the process for forming the mask involves a process shown at 42 for reshaping spheres in the exposed layer, according to another embodiment of the invention.

In the embodiment described, the process 32 for causing the plurality of spheres 36 to arrange into at least one layer 34 on the substrate surface 38 involves providing a few drops of mono-dispersed polystyrene sphere suspension on the substrate surface 38.

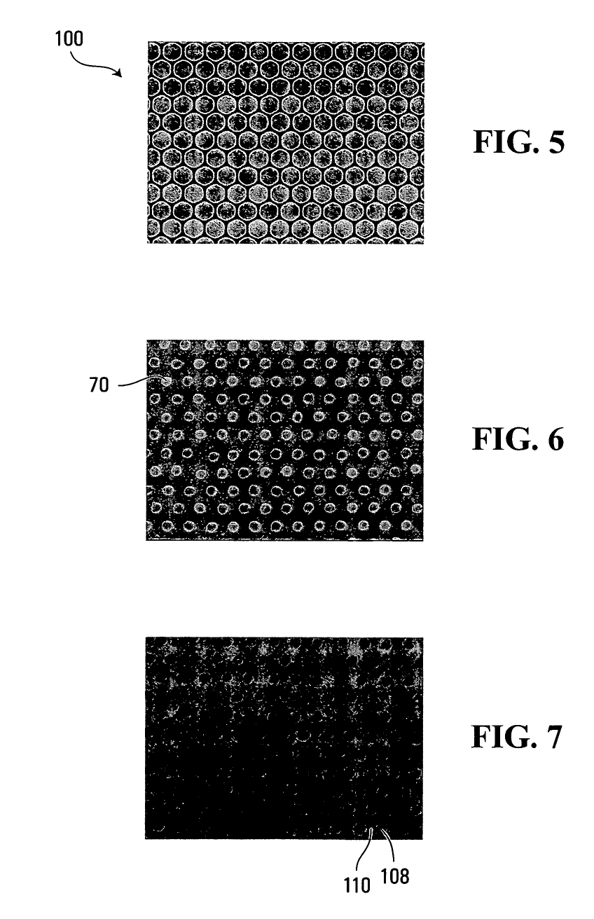

The suspension-covered substrate is then submerged in de-ionized (DI) water (not shown). A randomly arranged monolayer of polystyrene spheres is then formed on an upper surface of the DI water by adding a small amount of SDS solution (CH₃(CH₂)₁₁OSONa) to the DI water to drive the randomly arranged spheres into a closely packed monolayer of spheres on the surface of the water. The submerged suspension-covered substrate is then withdrawn from the DI water to transfer the closely packed monolayer of spheres on the surface of the water onto the substrate surface 38. The substrate 13 is then dried, leaving a single (monolayer) 34 of spheres 36 secured to the substrate surface 38, as shown in FIG. 2. This monolayer 34 of spheres 36 is the exposed layer. A picture of the monolayer 34 is shown at 100 in FIG. 5.

Once this first monolayer 34 of spheres 36 has been secured to the substrate surface 38, the substrate 13 is ready for the process of reshaping the spheres, shown generally at 42 in FIG. 2.

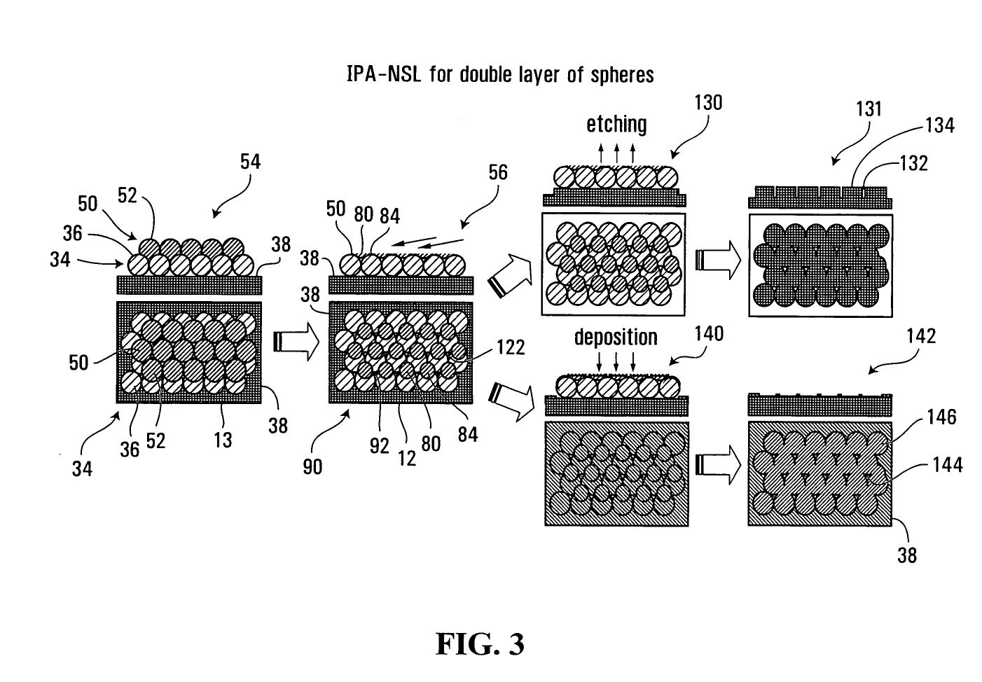

Alternatively, referring to FIG. 3, before reshaping the spheres, another layer 50 of spheres 52 may be added as shown at 54, following the same steps as above, wherein the substrate 13 with the first layer 34 of spheres 36 thereon is treated as “the substrate” and a second monolayer of spheres is formed on the first layer. The first layer 34 in this embodiment may be regarded as a substrate layer of spheres, while the second layer 50 on the substrate layer may be regarded as the exposed layer. The use of the second layer 50 may be desirable where very fine openings are required in the mask so formed, for example, as will be appreciated below.

Where the spheres are caused to arrange into a substrate layer 34 and an exposed layer 50 as described above, the substrate layer 34 has a certain packing density where the surface of any given sphere in the substrate layer touches, or almost touches surfaces of its neighboring spheres. Thus, a first set of interstices (best seen at 60 in FIG. 2) is defined between spheres of the substrate layer 34.

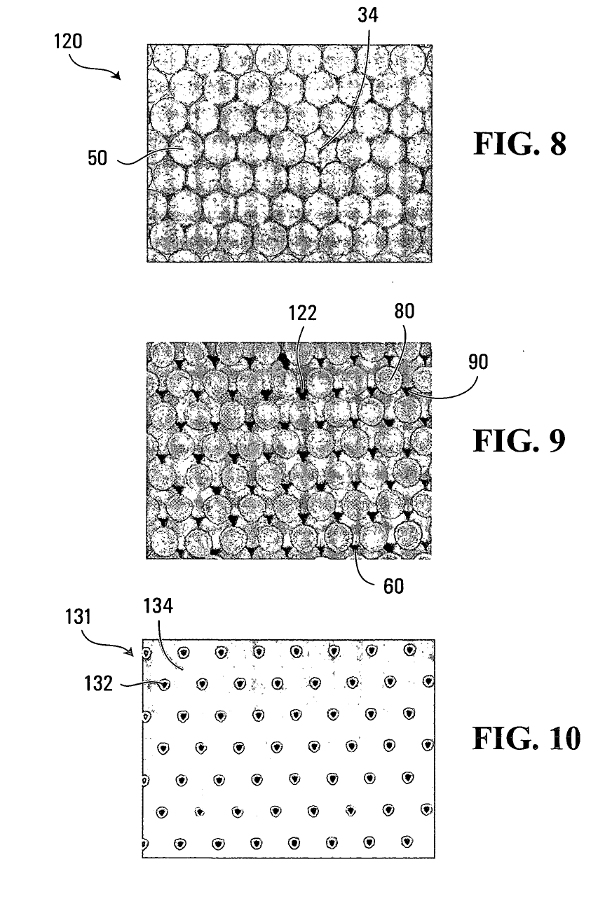

Referring back to FIG. 3, the spheres of the exposed layer 50 have a diameter the same as the spheres of the substrate layer 34 to provide for the same packing density as that of the substrate layer. These spheres of the exposed layer will generally tend to lie over interstice junctions between neighbouring spheres of the substrate layer 34. A picture of a substrate surface 38 with the substrate layer 34 and the exposed layer 50 thereon is shown generally at 120 in FIG. 8, with one sphere of the exposed layer removed to show the packing of the spheres of the substrate layer 34.

Re-Shaping the Exposed Layer

Referring to FIG. 2, the process 42 for reshaping the spheres 36 in the exposed layer, whether the exposed layer is directly on the substrate surface 38 or directly on the substrate layer of spheres as shown in FIG. 3 involves exposing the exposed layer of spheres to a low-angle ion beam, while maintaining the low-angle ion beam at a power level for a sufficient time to ablate the spheres in the exposed layer into respective spaced-apart sphere segments 70. In an embodiment where the exposed layer is directly on the substrate surface, i.e. there is only one layer of spheres on the substrate surface, the sphere segments 70 resulting from exposure to the low-angle ion beam define covered areas of the substrate surface and interstices between the sphere segments define uncovered areas of the substrate surface. The sphere segments 70 and interstices therebetween thus define a mask on the substrate surface 38. A picture of an exemplary mask formed by the sphere segments 70 is shown in FIG. 6.

In the embodiment shown in FIG. 3 where the exposed layer is on the substrate layer, i.e. there are two layers of spheres, a first set of interstices is defined between spheres in the substrate layer and a second set of interstices is defined between the spaced apart sphere segments of the exposed layer.

The sphere segments in the exposed layer and the spheres in the substrate layer thus define a mask on the substrate surface, in this embodiment.

A low-angle ion beam as used herein, is intended to include an ion beam having a direction vector 72 nearly parallel to a tangent 74 of the substrate surface 38 and spaced apart from the substrate surface. In this context “nearly parallel” means plus or minus about 10 degrees from exactly parallel to the tangent 74 to the substrate surface 38. The substrate surface 38 may be curved, hence the indication that the low-angle ion beam is nearly parallel to a tangent of the surface.

The low-angle ion beam is directed nearly parallel to the tangent 74 to the surface 38 and spaced apart from the substrate surface so that the beam has minimal, if any effect on the substrate surface. In other words, only the spheres 36 in the exposed layer 34 of spheres are affected by the low-angle ion beam, leaving the substrate surface 38 virtually untouched by the ion beam. A low-angle ion beam suitable for this purpose may be provided by an ion-polishing system such as may be obtained from Gatan Incorporated of Pleasanton, Calif. USA. An example of such a system is also known as a chemically-assisted ion beam milling system and is described in U.S. Pat. No. 5,009,743, for example which is incorporated herein by reference.

Exposing the exposed layer of spheres to the low-angle ion beam in this embodiment, involves maintaining the low-angle ion beam at a power level for a time sufficient to form generally planar surfaces 84 in the spheres in the exposed layer. The generally planar surfaces are generally circular and co-planar in this embodiment.

To create the floating gate flash memory shown in FIG. 1, referring to FIG. 2, spheres were arranged on the substrate surface 38 into a single exposed layer 34. Referring to FIG. 2, the spheres were formed of polystyrene and had a diameter 40 of approximately 300 nanometers. The spheres 36 were exposed to the above-described low-angle ion beam at a power level defined by a beam acceleration voltage of 4.9 keV and an ion current of 6 microamps. The spheres 36 were exposed to the ion beam at this power level for approximately 10.5 minutes. During this time, the substrate 13 and the ion beam were caused to move relative to each other, which, in this embodiment, was achieved by maintaining the ion beam in a fixed position while rotating the substrate in a plane nearly parallel to the direction of the low-angle ion beam. Thus, while the ion beam was maintained at a low angle relative to the plane of the substrate surface 38, the rotation of the substrate 13 relative to the beam provided for symmetrical removal of the top portions of the spheres 36 to make the spheres into sphere segments 70 having generally planar circular surfaces 76, having a final diameter 78 of about 40 nanometers, which is less than the initial diameter of 300 nanometers of the respective spheres in which the planar circular surfaces are formed. Generally, little more than the top hemispheres of the spheres 36 was removed, and the low-angle ion beam left no noticeable effect on the substrate surface 38. Thus, the substrate surface 38 was effectively maintained in its primordial state.

Effectively the substrate 13 with the above-described mask thereon may be regarded as a nano-structure array apparatus comprising a substrate 13 having a substrate surface 38 and a plurality of sphere segments 70 in spaced apart relation to form interstices 60 therebetween on the substrate surface, where the sphere segments define covered areas on the substrate surface and the interstices define uncovered areas on the substrate surface, as shown in FIG. 6.

Referring to FIG. 3, in the embodiment in which the substrate layer 34 and exposed layer 50 are employed, the exposed layer 50 is exposed to the low-angle ion beam as shown at 56. By maintaining the ion beam at a power level for a sufficient time as described above, the spheres 52 of the exposed layer 50 are ablated to form sphere segments 80 having a diameter less than the diameter of the original spheres from which they were produced and this results in every second interstitial junction of the substrate layer of spheres being covered by a sphere segment of the exposed layer while intervening interstitial junctions of the substrate layer are uncovered. Thus, sphere segments 80 in the exposed layer 50 and spheres 36 in the substrate layer 34 cover respective areas of the substrate surface 38 and interstices between the sphere segments and interstices between spheres of the substrate layer define uncovered areas of the substrate surface. These covered and uncovered areas effectively provide the mask in this embodiment.

Thus, using the above-described process, a masked substrate apparatus 90 for use in forming a nanostructure array is formed and includes a substrate 13 having a substrate surface 38, a plurality of spheres 36 in a substrate layer 34 of spheres on the substrate surface, a first set of interstices 60 formed between adjacent spheres of the substrate layer and a plurality of sphere segments 80 on an exposed layer 50 of sphere segments on the substrate layer of spheres wherein the sphere segments 80 are arranged in spaced-apart relation to form a second set of interstices 92 between adjacent sphere segments. The interstices 60 of the first set and the interstices 92 of the second set have overlapping areas that define uncovered areas on the substrate surface 38 and the spheres 36 of the substrate layer 34 and the sphere segments 80 of the exposed layer 50 cover areas of the substrate surface 38 to define covered areas of the substrate surface.

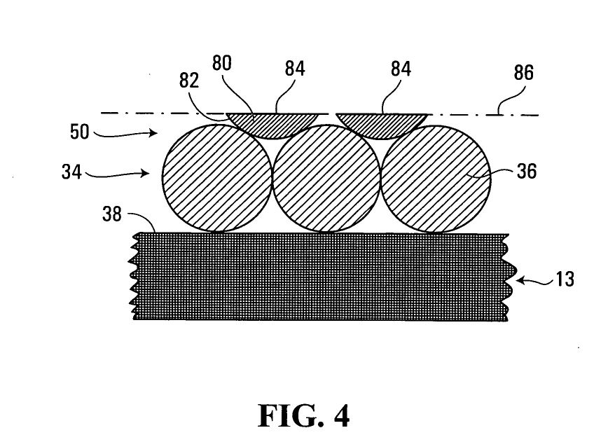

Referring to FIG. 4, in the two-layer embodiment shown, each of the sphere segments 80 of the exposed layer 50 of sphere segments has a curved surface 82 and a generally planar surface 84 that has been formed by the low-angle ion beam. The sphere segments 80 are on the substrate layer 34 of spheres 36 on the substrate surface 38 such that the curved surfaces 82 of the sphere segments 80 face generally toward the substrate layer 34 and such that the generally planar surfaces 84 of the sphere segments face away from the substrate layer 34. The generally planar surfaces 84 of the sphere segments 80 generally lie in a common plane 86 spaced apart from the substrate surface 38.

Referring back to FIG. 3, the use of the substrate layer 34 and the exposed layer 50 provides for very small uncovered areas of the substrate surface. These very small uncovered areas are smaller than the spheres themselves and are much easier to control in size since the rate of change of the diameter of the planar circular surfaces (84 in FIG. 4) of the spheres in the exposed layer, due to the low-angle ion beam, is relatively small as the diameters of the spherical segments are decreased after the ion beam ablates outer hemispheres of the spheres in the exposed layer and begins ablating the lower hemispheres thereof. Thus, the decrease in covering provided by the further low-angle ion beam ablation of the lower hemispheres of the spheres in the exposed layer 50 coupled with the fixed covering or non-ablated surfaces of the spheres of the substrate layer 34 provides for careful reduction of the covered areas of the substrate surface 38 and thus allows for careful control of the uncovered areas of the substrate surface. In other words, the use of the substrate layer 34 and the exposed layer 50 facilitates “tuning” very small openings in the mask formed by the combined covering effect of the spheres and sphere segments in these layers.

Two embodiments of sphere arrangements have been described—a single layer embodiment and a double layer embodiment. More generally, more than two layers of spheres may be used. How they are used, depends upon the stacking of the sphere layers. The stacking depends upon the crystal structure of the spheres. There are two types of crystal structures: fcc and hcp, which differ in the stacking of (111) layers. Crystal structures of the fcc type: stack in an “ABCABC” form and crystal structures of the hcp type stack in an “ABAB” form. In the ABCABC form (fcc), the interstices are completely covered. In this case the process involves an additional step of ablating all of the upper or distal layers away until the second layer is reached whereupon the interstices start to become exposed. The second layer is then ablated by the ion beam in the manner described above such that sphere segments are produced from the exposed layer and the sphere segments and the substrate layer act to define covered and uncovered areas on the substrate surface.

When crystal structures stack in the ABAB form, the interstices between spheres in each layer are aligned such that they form a generally columnar void within the layers and the area defined by this columnar void can be tuned by exposing the exposed layer of spheres, i.e. the outer layer, to the low angle ion beam to increase the size of the uncovered area on the substrate surface.

Subsequent Steps

Regardless of whether the single exposed layer of spheres is employed to form the mask or the substrate layer and exposed layer of spheres is used to form the mask, the sphere segments resulting from ion beam exposure and, in the case where two layers of spheres are used, the substrate layer of spheres, define covered and uncovered areas of the substrate surface 38. The uncovered areas may be etched, for example. As shown at 90 in FIG. 2, the masked substrate 13 may be subjected to plasma etching such as Reactive Ion Etching (RIE) which etches the substrate surface 38 in the uncovered areas, creating a plurality of recesses 95 in the surface. As shown at 94 in FIG. 2, the layer of spherical segments may then be removed by sonication and dissolution in toluene leaving an ordered array of projections 96 separated by the recesses 95, in the substrate surface 38 of the substrate 13.

Alternatively, also with the single layer of spheres, as shown at 102 in FIG. 2, the masked substrate may be subjected to a metal deposition process wherein a thin layer of metal is deposited on the sphere segments 70 remaining in the exposed layer 34 such that some of the metal is deposited on the uncovered areas of the substrate surface 38. The metal thus covers the sphere segments 70 and the uncovered substrate surface is accessible through the interstices 60 between the sphere segments.

As shown at 104 in FIG. 2, the sphere segments 70 are then removed from the surface 38 using sonication or dissolution in toluene, leaving the substrate with a plurality of unmetallized areas 105 which can then be etched by RIE, for example, as shown at 106 in FIG. 2 to form an ordered array of recesses 108 in the substrate surface 38 with upstanding metallized portions 110 of the substrate around and defining the recesses as shown in FIG. 7.

These latter processes shown at 102, 104 and 106 in FIG. 2 were used to deposit the silver nano-dots on the substrate surface 38 of the floating gate flash memory shown in FIG. 1 and then the areas around the nano-dots were etched to clearly define the dots. The resulting dots had a diameter of about 10 nm and a thickness of about 2.5 nm. Then, referring back to FIG. 1, the second thin film of aluminum oxide 24 was deposited on the nano-dots and then the aluminum control gate 28 was formed to complete the floating gate flash memory.

In embodiments in which a substrate layer 34 and an exposed layer 50 of spheres are used, the spheres are arranged on the substrate surface as shown at 120 in the electron microscope picture shown in FIG. 8 and as shown at 54 in FIG. 3. As shown at 56 in FIG. 3, the exposed layer 50 of spheres 52 is then exposed to the low-angle ion beam, creating sphere segments in the exposed layer 50 as shown at 80 in FIGS. 2 and 9. In this embodiment, as a result of the ion exposure process shown at 56 in FIG. 3, the substrate surface is left with generally triangular-shaped uncovered areas 122 defined by overlapping areas of the first set of interstices 60 between the spheres of the substrate layer and the second set of interstices 93 defined by the sphere segments 80 in the exposed layer 50.

In one embodiment, as shown at 130 in FIG. 3, the substrate with the sphere segments and substrate layer of spheres thereon is subjected to an etching process whereby etching such as RIE is performed to etch the uncovered areas of the substrate surface 38. As shown at 131 in FIGS. 3 and 10, this leaves the substrate surface 38 with a plurality of small recesses 132 defined between much larger massive areas 134 of solid substrate material thereof.

Alternatively, as shown at 140 in FIG. 3, the layers of spheres may be subjected to a metal deposition process wherein a thin layer of metal is deposited on the exposed layer of spheres and is blocked from the substrate surface by the sphere segments of the exposed layer and the spheres of the substrate layer, allowing only the uncovered areas of the substrate surface defined by the first and second sets of interstices to receive metal deposition.

As shown at 142 in FIG. 3, the spheres are then removed from the substrate surface by sonication and dissolution in toluene, leaving metal covered areas 144 and uncovered areas 146 of the substrate surface 38. The substrate surface 38 may then be subjected to plasma etching (not shown), which etches the uncovered areas and leaves the metal covered areas, effectively leaving a plurality of very small metal “dots” (not shown) on the substrate surface.

From the foregoing, it will be appreciated that by exposing an exposed layer of spheres on a substrate layer of spheres or directly on a substrate surface to a low-angle ion beam, sphere segments are formed in the exposed layer. The sphere segments of the exposed layer, and where a substrate layer is also used, spheres of the substrate layer, act to define covered and uncovered areas of the substrate surface, providing a mask on the substrate surface. The mask is tunable by adjusting the power level and exposure time of the exposed layer of spheres to the low-angle ion beam. The use of the low-angle ion beam has minimal effect on the substrate surface and provides for relatively fine adjustment of the covered and uncovered areas of the substrate surface.

The processes and apparatus described herein may be used to fabricate low dimensional optical, electronic, magnetic and optoelectronic devices, filters, bioreactors, biosensors, bioprobes, chemical sensors, data storage media and may be used to fabricate devices for catalysis, for example.

While the description above has described the use of polystyrene spheres, silica, metal, and/or semiconductor or other materials may be substituted and etching plasmas for use in the later etching step may be selected according to sphere material.

While specific embodiments of the invention have been described and illustrated, such embodiments should be considered illustrative of the invention only and not as limiting the invention as construed in accordance with the accompanying claims.

What is claimed is:

1. A process for re-shaping spheres in an exposed layer of spheres on a substrate having a substrate surface, the process comprising:
exposing the exposed layer of spheres to a low-angle ion beam, while maintaining said low-angle ion beam at a power level for a time sufficient to ablate the spheres in the exposed layer into respective spaced apart sphere segments.

2. The process of claim 1 wherein exposing comprises causing said low-angle ion beam to be directed at the spheres in the exposed layer in a direction nearly parallel to a tangent of the substrate surface and spaced apart from the substrate surface.

3. The process of claim 1 wherein maintaining said low-angle ion beam at a power level comprises maintaining said low-angle ion beam at a power level for a time sufficient to form generally planar surfaces in the spheres in the exposed layer, said generally planar surfaces being generally coplanar.

4. The process of claim 3 wherein maintaining said low-angle ion beam at a power level for a time sufficient to create generally planar surfaces comprises maintaining said low-angle ion beam at a power level for a time sufficient to create generally planar circular surfaces in the spheres in the exposed layer, said generally planar circular surfaces having a final diameter less than an initial diameter of a respective sphere in which they are formed.

5. The process of claim 4 further comprising causing the substrate and ion beam to move relative to each other.

6. The process of claim 5 wherein causing the substrate and ion beam to move relative to each other comprises maintaining the ion beam in a position while rotating the substrate.

7. The process of claim 1 wherein exposing said exposed layer of spheres to said low-angle ion beam comprises ion beam polishing said exposed layer of spheres.

8. The process of claim 1 wherein the exposed layer is directly on the substrate surface.

9. The process of claim 1 wherein the exposed layer is on an substrate layer of spheres and wherein said substrate layer of spheres is directly on the substrate surface.

10. The process of claim 1 wherein the spheres have an initial diameter of between about 70 nm to about 5 μm.

11. The process of claim 1 wherein the spheres are nanospheres.

12. A process for forming a mask on a substrate surface, the process comprising:
causing a plurality of spheres to arrange into at least one layer of spheres on the substrate surface, each of the spheres having a first diameter and said at least one layer including an exposed layer of spheres; and then executing the process of claim 1.

13. The process of claim 12 wherein causing said plurality of spheres to arrange into said at least one layer of spheres comprises causing said plurality of spheres to arrange into a single layer of spheres on the substrate surface, said single layer of spheres being the exposed layer of spheres.

14. A process for producing a nanostructure array comprising the process of claim 13 wherein said sphere segments in the exposed layer cover respective areas of the substrate surface, and interstices between respective said sphere segments define uncovered areas of the substrate surface, and further comprising etching said uncovered areas of said substrate surface.

15. A nanostructure array apparatus produced according to the process of claim 14.

16. A process for producing a nanostructure array comprising the process of claim 13 wherein said sphere segments in the exposed layer cover respective areas of the substrate surface, and interstices between respective said sphere segments define uncovered areas of the substrate surface, and further comprising ablating said uncovered areas of said substrate surface.

17. A nanostructure array apparatus produced according to the process of claim 16.

18. A process for producing a nanostructure array comprising the process of claim 13 wherein said sphere segments in the exposed layer cover respective areas of the substrate surface, and interstices between respective said sphere segments define uncovered areas of the substrate surface, and further comprising depositing material on said uncovered areas of said substrate surface.

19. A nanostructure array apparatus produced according to the process of claim 18.

20. The process of claim 12 wherein causing said plurality of spheres to arrange into said at least one layer of spheres comprises causing said plurality of spheres to arrange into a substrate layer of spheres and said exposed layer of spheres, said substrate layer of spheres being on the substrate surface and said exposed layer of spheres being on said substrate layer of spheres.

21. A process for producing a nanostructure array comprising the process of claim 20 wherein said sphere segments in the exposed layer and the spheres in said substrate layer cover respective areas of the substrate surface, and wherein interstices between said sphere segments and interstices between spheres of said substrate layer define uncovered areas of the substrate surface and further comprising etching said uncovered areas of said substrate.

22. A nanostructure array apparatus produced according to the process of claim 21.

23. A process for producing a nanostructure array comprising the process of claim 20 wherein said sphere segments in the exposed layer and the spheres in said substrate layer cover respective areas of the substrate surface, and wherein interstices between said sphere segments and interstices between spheres of said substrate layer define uncovered areas of the substrate surface and further comprising ablating said uncovered areas of said substrate.

24. A nanostructure array apparatus produced according to the process of claim 23.

25. A process for producing a nanostructure array comprising the process of claim 20 wherein said sphere segments in the exposed layer and the spheres in said substrate layer cover respective areas of the substrate surface, and wherein interstices between said sphere segments and interstices between spheres of said substrate layer define uncovered areas of the substrate surface, and further comprising depositing material on said uncovered areas of said substrate.

26. A nanostructure array apparatus produced according to the process of claim 25.

27. A masked substrate apparatus for use in forming a nanostructure array, the apparatus comprising:
a substrate having a substrate surface;
a plurality of spheres in a substrate layer of spheres on the substrate surface, wherein a first set of interstices is formed between adjacent spheres of said substrate layer; and
a plurality of sphere segments in an exposed layer of sphere segments on said substrate layer of spheres, said sphere segments being arranged in spaced apart relation to form a second set of interstices between adjacent said sphere segments, said interstices of said first set and said interstices of said second set having overlapping areas defining uncovered areas on the substrate surface and the spheres of said substrate layer and said sphere segments of the exposed layer covering areas of the substrate surface to define covered areas of the substrate surface.

28. The apparatus of claim 27 wherein each of said sphere segments has a curved surface and a generally planar surface that has been formed by a low-angle ion beam, and wherein said sphere segments are on said substrate layer of spheres on said substrate surface such that said curved surfaces of said sphere segments face generally towards said substrate layer of spheres and said generally planar surfaces of said sphere segments face away from said substrate layer of spheres.

29. The apparatus of claim 28 wherein said substrate surface is generally planar and wherein said generally planar surfaces of said sphere segments generally lie in a common plane spaced apart from said substrate surface.

30. The apparatus of claim 27 wherein said spheres have a diameter of between about 70 nm to about 5 μm.
